(19) United States
(12) Patent Application Publication
(10) Pub. No.: US 2015/0234942 A1
(43) Pub. Date: Aug. 20, 2015

(54) METHOD OF MAKING A MASK WITH CUSTOMIZED FACIAL FEATURES

(71) Applicant: Possibility Place, LLC, St. Louis, MO (US)

(72) Inventor: Scott A. Harmon, Concord, MA (US)

(21) Appl. No.: 14/615,421

(22) Filed: Feb. 5, 2015

Related U.S. Application Data
(60) Provisional application No. 61/940,094, filed on Feb. 14, 2014.

(51) Int. Cl. G06F 17/50; H04N 13/02; G06K 9/00

(52) U.S. Cl. CPC G06F 17/50; G06K 9/00268; H04N 13/02

(57) ABSTRACT

A method of making a mask of a subject's face having a shape adapted to interfit with a corresponding mask-receiving portion on a head, includes the steps of obtaining at least 3D image data of the subject's face; computer processing the 3D image data using facial feature recognition software to identify preselected facial landmarks in the 3D image data; aligning the image represented by the 3D image data with a mask model using at least one of the identified preselected facial landmarks; projecting the perimeter of the aligned mask model on the aligned image represented by 3-D image data; trimming the image represented by the 3D image data to the projected perimeter of the aligned mask model; bending the edge portions of the image represented by the 3D image data to manage the gap between the edge perimeter of the image represented by the 3D image and the edge perimeter of the mask model; generating image data to fill the gap between the edge perimeter of the image represented by the 3D image and the edge perimeter of the mask model, and mating the image represented by the 3D image data to a mask data set.

### CROSS-REFERENCE TO RELATED APPLICATIONS

This application claims priority to U.S. Provisional Patent Application Ser. No. 61/940,094 filed Feb. 14, 2014. The entire disclosure of the above application is incorporated herein by reference.

### BACKGROUND

This section provides background information related to the present disclosure which is not necessarily prior art.

This invention relates to making dolls and action figures with customized facial feature, and in particular to making masks for dolls and action figured with customized facial features.

Dolls and actions figures that are customized to resemble particular people are highly desirable, but because they must be custom made, requiring skilled labor and expensive equipment, they take a long time to produce and can be expensive. Improvements in technology including scanners and 3D printers allow custom heads or custom heads and bodies to be made, but the process still takes time, is expensive, and the results are not very realistic.

### SUMMARY

This section provides a general summary of the disclosure, and is not a comprehensive disclosure of its full scope or all of its features.

Embodiments of the present invention provide methods for making a mask with customized facial features of a subject, which can be used to customize a preformed head or head and body. Generally, the method comprises obtaining at least 3D image data of the subject's face. This 3D image data is processed by computer using facial feature recognition software to identify preselected facial landmarks in the 3D image data. The image represented by the 3D image data is aligned with a mask model using at least one of the identified preselected facial landmarks. The perimeter of the aligned mask model is projected on the aligned image represented by 3-D image data. The image represented by the 3D image data is trimmed to the projected perimeter of the aligned mask model. The edge portions of the image represented by the 3D image data are bent to manage the gap between the edge perimeter of the image represented by the 3D image and the edge perimeter of the mask model. Image data is generated to fill the gap between the edge perimeter of the image represented by the 3D image and the edge perimeter of the mask model. The image represented by the 3D image data is mated to a mask data set.

In some embodiments, at least some portions of the image associated with the 3D image data adjacent to at least some of the identified preselected facial landmarks are tone mapped using a restricted range of colors similar to a preselected skin tone color, and at least some other portions of the image are replaced with the preselected skin tone color.

In some embodiments the eyes on the image represented by the 3D image data are identified using at least some of the identified preselected facial landmarks, and enlarged by a predetermined amount. The step of identifying the eyes can include identifying the eyebrows, and the step of enlarging the eyes includes enlarging the eyebrows.

In some embodiments the eyes are identified using at least some of the identified preselected facial landmarks, and the edge margins of the eyes are whitened and/or a ring around the center, with a color based upon an the existing color at a location in the image being colored, or one of a number of predetermined colors, or one selected by the user or the subject. Alternatively or in addition, the subject's teeth can be identified using at least some of the identified preselected facial landmarks, and recolored. This color can be based in part upon a color existing in the image at the location being colored; it can be one of a predetermined number of colors, or it can be color selected by the user or the subject.

In some embodiments, one of a plurality of predetermined make up patterns can be applied to the image represented by the 3D data, based at least in part upon processing the 3D image data. The selection of one of the plurality of predetermined make up patterns can be based at least in part upon data about the subject, and/or at least in part upon user or selection.

In some embodiments the step of mating the image represented by the 3D image data to a mask model perform comprises selecting one of a plurality of mask models preforms based upon the distance and/or angles between at least two of the preselected facial landmarks, and preferably based upon two mutually perpendicular distances. The distances between the landmarks on the image represented by the 3D image data are preferably scaled according to the model preform selected. The scaling can be different depending upon direction the degree of scaling in the vertical direction can be different than the degree of scaling in the horizontal direction.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a flow chart of a preferred embodiment of method of making a mask with customized facial features;

FIG. 2 is a 2D screen display of a 3D image acquired by processing two 2D images of the subject;

FIG. 3 is a 2D screen display of a 3D image acquired by processing two 2D images of the subject, after application of some of the optional image enhancements;

FIG. 4 is a depiction of overlaying the 3D image on a 3D mask model;

FIG. 5 is a 2D screen display of a 3D image showing the automatic identification of facial landmarks;

FIGS. 6A and 6B are 2D screen displays illustrating how at least some of the automatically identified facial landmarks on the 3D image are used to align the 3D image with a 3D mask model;

FIG. 7 is a 2D screen display

FIG. 8 is a 2D screen display showing the combination of the 3D image with the selected 3D mask model;

FIG. 9 is a 2D screen display showing the 3D image;

FIG. 10 is a 2D screen display showing the combination of the 3D image with the selected 3D mask model; and

FIG. 11 is a 2D screen display showing the generated 3D image data to fill in the gaps between the 3D image and the 3D mask model.

Corresponding reference numerals indicate corresponding parts throughout the several views of the drawings.

### DETAILED DESCRIPTION

Example embodiments will now be described more fully with reference to the accompanying drawings.

Embodiments of the present invention provide methods for making a mask with customized facial features of a subject, which can be used to customize a preformed head or head and body. Thus embodiments of the invention can be used to create dolls of any type and size, action figures of any type and size, and any other form factor that includes a head, and provide such doll, action figure, or form factor with facial features customized to resemble a particular subject.

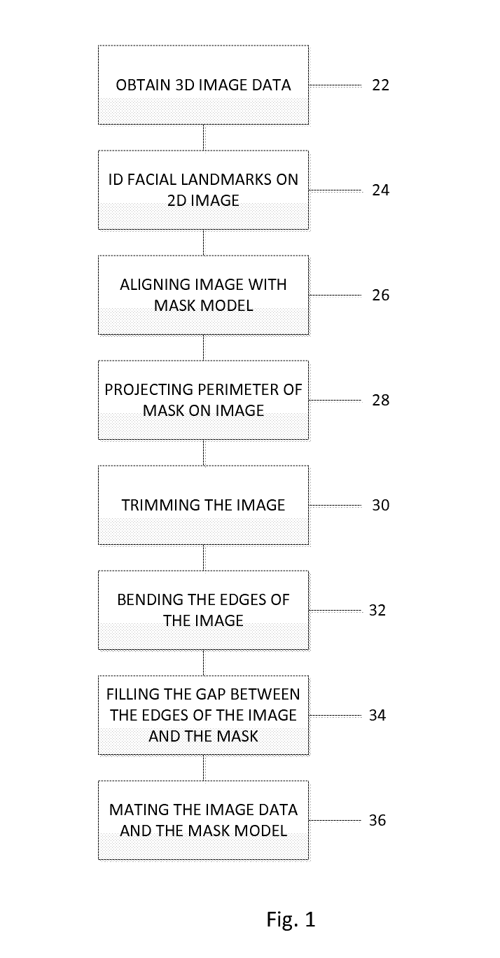

As shown in FIG. 1, the method comprises at 22, obtaining at least 3D image data of the subject's face. This can be accomplished using any of a variety of 3D scanning technologies or sensor technologies, including but not limited to photogrammetry (stitching together two or more 2D images), structured light 3D scanning, laser scanning white light imaging, time of flight scanning, or other suitable 3d image acquisition methods.

At 24 2D image data is processed by computer using facial feature recognition software such as is available from Verilook SDK (Neurotechnology), Luxand Face SDK, or Visage Face Detect SDK to identify preselected facial landmarks in the 2D image data. These landmarks can include the center of the eyes, the edges of the eyes, the top of the eye, the bottom of the eye, the edges of the mouth, the top of the mouth, the bottom of the mouth, the tip of the nose, the edges of the nostrils, the edges of the cheeks, and the chin.

The 2D image data with the preselected facial landmarks identified is projected onto the 3D image. This can be done by uv mapping.

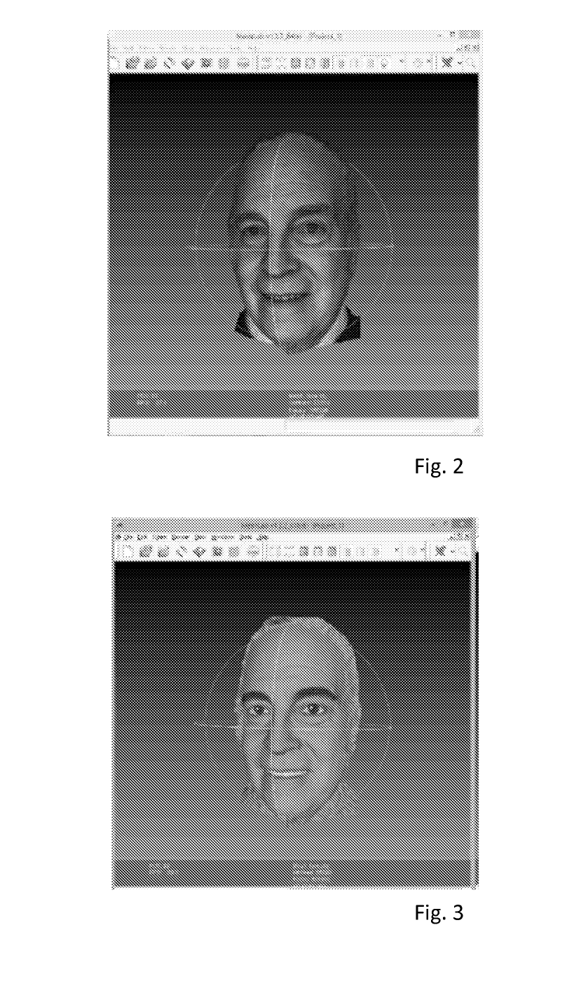

At 26 the image represented by the 3D image data is aligned with a mask model using at least one of the identified preselected facial landmarks. For example the center of the eyes can be used to roughly align the 3D image 100 and the mask model 102 as shown in FIG. 2. Of course additional landmarks can be used such as the corners of the mouth, or other facial landmarks. The 3D image can be scaled, moved, or rotated as part of this alignment process. The scaling, movement, and rotations is controlled to minimize the error (i.e., distance) between the corresponding landmarks on the 3D image and the mask model.

After an initial alignment using selected landmarks, the 3D image is more closely aligned with the mask model using ICP (iterative closest point) matching.

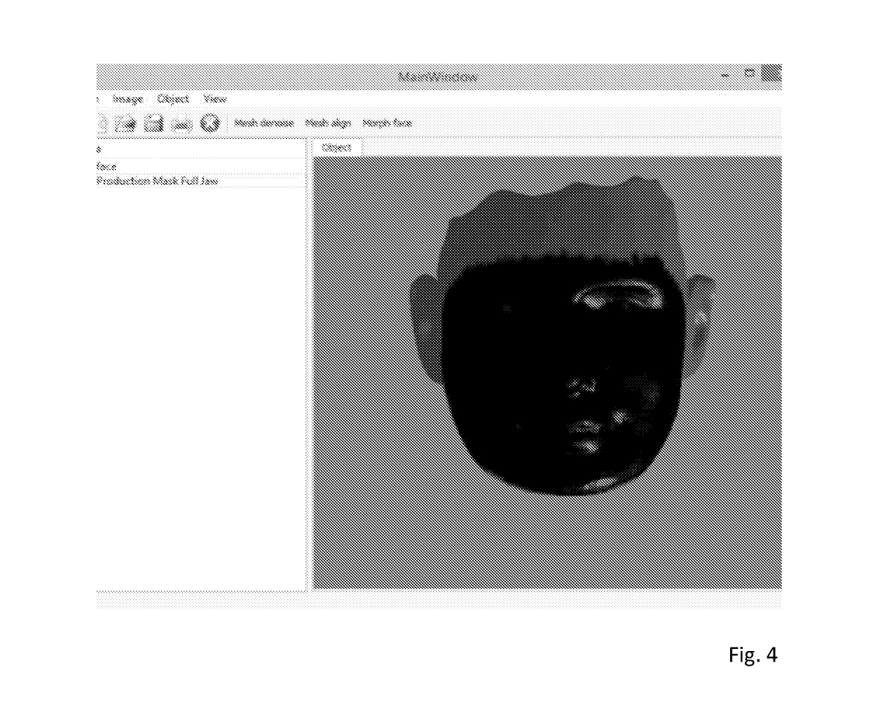

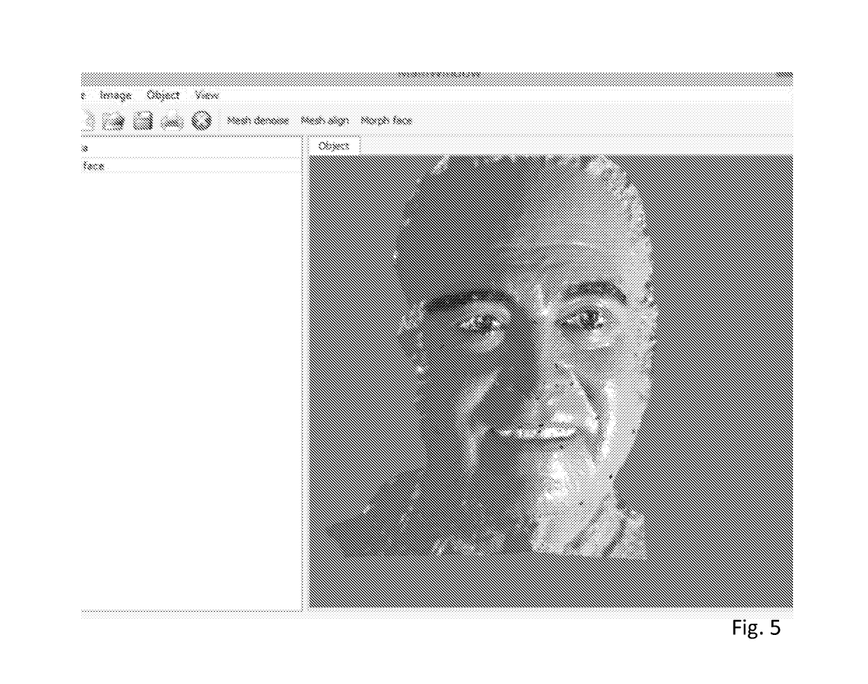

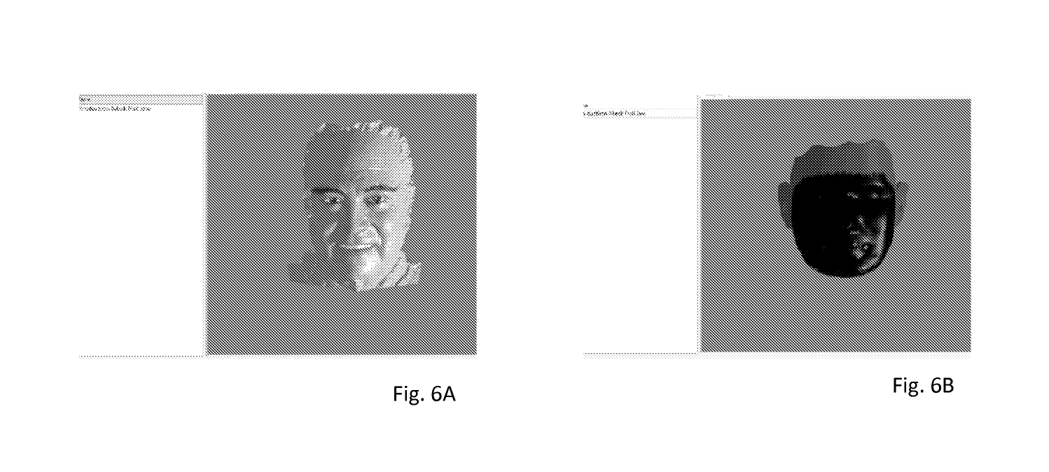

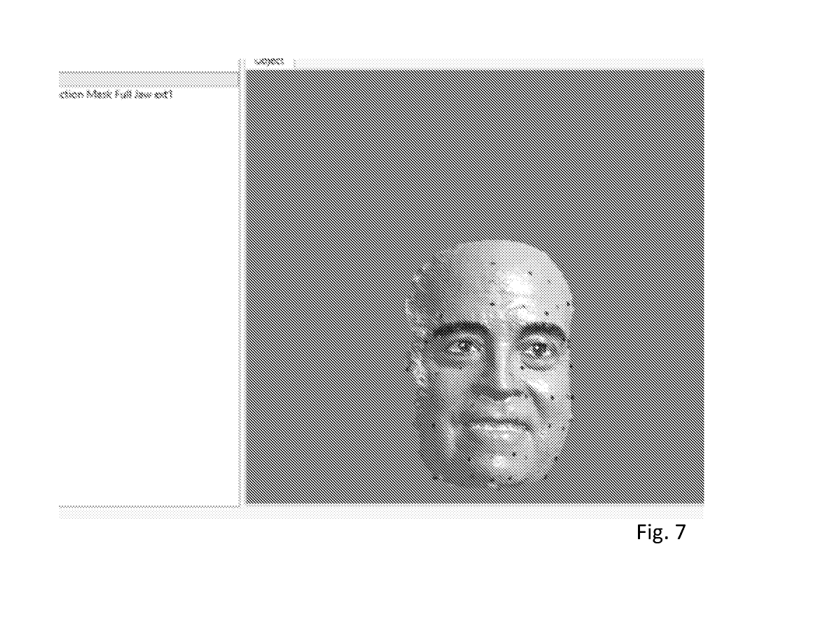

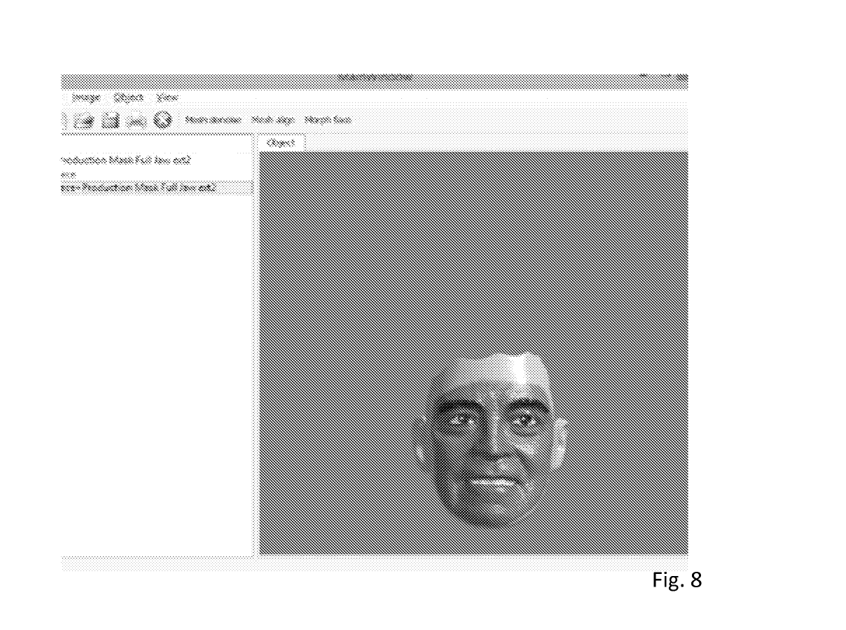

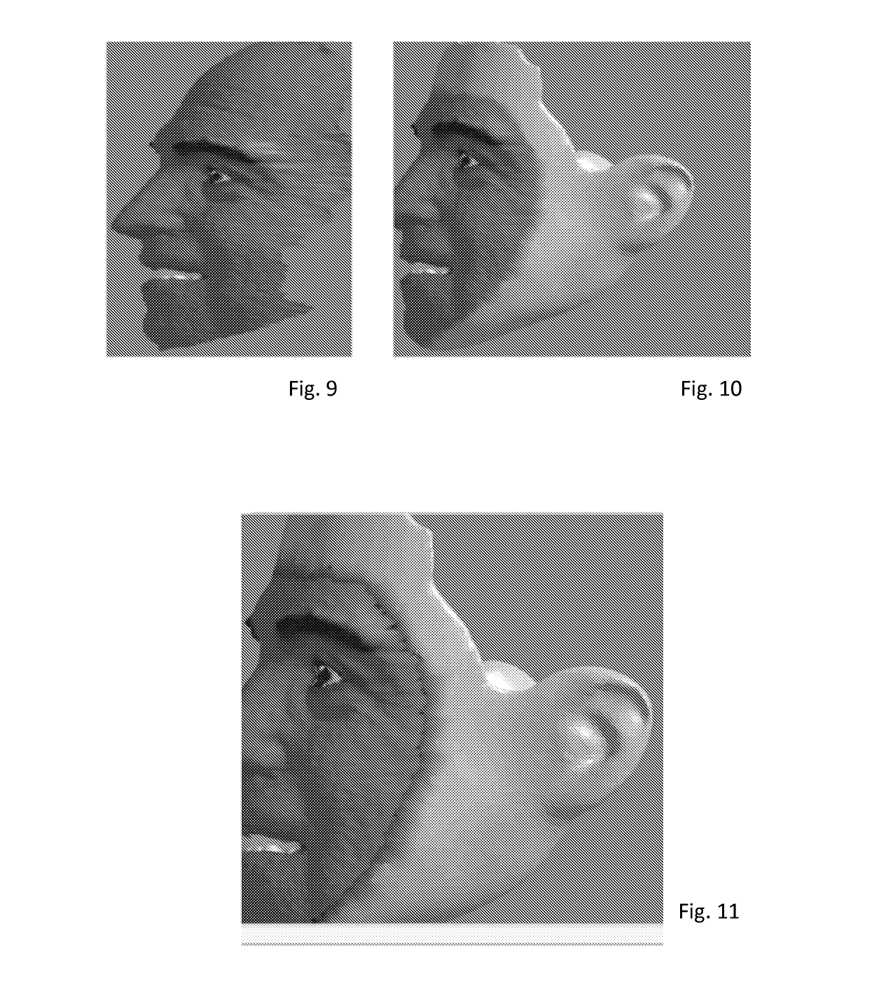

The mask model includes a replaceable region for receiving the 3D image data, and at 28 the perimeter of this replaceable region on the mask model is projected onto the aligned 3-D image data. As described below, more than one mask model can be provided to accommodate faces of different sizes and shapes. Each mask model has a different replaceable section (shown in FIG. 4). As described below, the appropriate mask model can be selected based upon the dimensions and/or ratios of facial landmarks identified in the 3D image data.

At 30 the 3D image data is trimmed to the projected perimeter of the replaceable region of the aligned mask model.

At 32 the 3D image data is manipulated to manage the gap between the edge perimeter of 3D image data and the edge perimeter of the replaceable region of the mask model. This manipulating of the 3D image data is accomplished by software that is programmed to manipulate the 3D image data in a controlled manner to maintain realistic facial features resembling the subject. The manipulation is preferably conducted to minimize the distortion of the 3D image data and minimize the gap between the edges of the 3D image data and the edges of the replaceable region of the mask model. The manipulation is controlled by a weighting function that generally permits increasing manipulation toward the edges of the 3D image data.

At 34 new image data is generated to fill the gap between the edge the 3D image data and the edge perimeter of the replaceable region of the mask model. This data can be generated by software using spline interpolation based upon the contour of adjacent surfaces.

At 36 the mask (the combination of the 3D image data and the mask model) can then be printed on a three dimensional printer, such as a Projet 660Pro from 3D Systems, the MCOR IRIS, or the Stratasys Connex 3D Printer. The masks can then be mounted on the head of a doll, action figure, or other form factor.

In some embodiments, at least some portions of the image associated with the 3D image data adjacent to at least some of the identified preselected facial landmarks are tone mapped using a restricted range of colors similar to a preselected skin tone color. This preselected skin tone color preferably corresponds to the skin tone color of the head on which the mask will be mounted. The remaining portions of the image (typically those adjacent the edges of the mask) are preferably colored with the preselected skin tone color, so that the mask will unobtrusively blend in with the head on which the mask is mounted.

In one implementation heads in a plurality of colors are provided, and a head color is selected for a particular subject that most closely resembles the subject's actual skin color. Preferably at least two (for example light and dark), and more preferably at least three (light, medium, and dark) skin colors. The inventors have found that providing three skin tones is sufficient to recognizably depict most subjects, while minimizing the required inventory of form factors. The mask that is created according to the various embodiments of this invention preferably has a color corresponding to the skin color of the selected form factor, so that the mask blends in with the form factor. Selected portions of the image (such as surrounding the eyes, nose and mouth) are colored with a range or gradient of color based upon the color of the form factor. These are the areas that are most important in recognizing the facial features. The edge margins of these areas preferably feather or smoothly transition to the surrounding areas to avoid abrupt changes of color. The remaining or surrounding portions of the image can be colored with a single color corresponding to the selected color of the form factor.

In some embodiments of the methods various facial features are modified. Most people have become accustomed to certain anatomical inaccuracies in many dolls, action figures, and other form factors. For a doll to appear natural or normal it is often necessary to resize or rescale some of the facial features. Furthermore to be recognizable, some small facial features need to be resized or rescaled so that they are sufficiently large to be seen. Thus, for example to be able to see the whites of the subject's eyes, or the color of the subject's iris's the eyes may have to be resized, for example increased by a predetermined amount between 10% and 25%, or increased to a predetermined size. The step of identifying the eyes can include identifying the eyebrows, and the step of enlarging the eyes can include enlarging the eyebrows.

In some embodiments the eyes are identified using at least some of the identified preselected facial landmarks, and the edge margins of the eyes are improved, e.g. whitened. Alternatively, or in addition, a ring around the center of the eye can form a colored iris. The color can be selected based upon an the existing color at a location in the image being colored, or one of a number of predetermined colors, or one selected by the user or the subject. In still other embodiments, alternatively or in addition, the subject's teeth can be identified using at least some of the identified preselected facial landmarks, and recolored. This color can be based in part upon a color existing in the image at the location being colored; it can be one of a predetermined number of colors, or it can be color selected by the user or the subject.

In some embodiments, one of a plurality of predetermined make up patterns can be applied to the image represented by the 3D data, based at least in part upon processing the 3D image data. The selection of one of the plurality of predetermined make up patterns can be based at least in part upon data about the subject, and/or at least in part upon user or selection.

In some embodiments, the step of mating the image represented by the 3D image data to a mask model preform comprises selecting one of a plurality of mask models preforms based upon the distances and/or angles between at least two of the preselected facial landmarks. Thus various dimensions and ratios are calculated for the 3D image, and one of a plurality of mask models is selected that is most compatible with the 3D image based upon these distances and/or angles. For example the mask preform could be selected based upon an aspect ratio of the 3D image, for example a ratio of a horizontal distance to a vertical distance on the 3D image, or a vertical distance to a horizontal distance on the 3D image.

As described above, unless the 3D image is a close match to the selected model preform, the 3D image can be scaled to better fit the mask model preform. This scaling can be uniform (i.e., the same in all directions), or differential (i.e., different in different directions). For example, the horizontal distance between the centers of the eyes in the 3D image is 1.1 times distance between the centers of the eyes in the selected model preform, and the distance between the center of the space between the eyebrows and the chin in the 3D image is 0.9 times the distance between the center of the space between the eyebrows and the chin in the selected model preform, the 3D image will be compressed in the horizontal direction, and stretched in the vertical direction. Of course the scaling is not limited to mutually perpendicular horizontal and vertical directions, and other scaling schemes can be implement to achieve a good fit between the 3D image and the selected mask preform.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of making a mask of a subject's face having a shape adapted to interfit with a corresponding mask-receiving portion on a head, the method comprising:
obtaining at least 3D image data of the subject's face;
computer processing the 3D image data using facial feature recognition software to identify preselected facial landmarks in the 3D image data;
aligning the image represented by the 3D image data with a mask model using at least one of the identified preselected facial landmarks;
projecting the perimeter of the aligned mask model on the aligned image represented by 3-D image data;
trimming the image represented by the 3D image data to the projected perimeter of the aligned mask model;
bending the edge portions of the image represented by the 3D image data to manage the gap between the edge perimeter of the image represented by the 3D image and the edge perimeter of the mask model;
generating image data to fill the gap between the edge perimeter of the image represented by the 3D image and the edge perimeter of the mask model,
and mating the image represented by the 3D image data to a mask data set.

2. The method according to claim 1 further comprising:
tone mapping at least some portions of the image associated with the 3D image data adjacent to at least some of the identified preselected facial landmarks using a restricted range of colors similar to a preselected skin tone color; and
replacing at least some other portions of the image with the preselected skin tone color.

3. The method of making a mask according to claim 1, comprising:
identifying the eyes on the image represented by the 3D image data using at least some of the identified preselected facial landmarks, and enlarging the eyes by a predetermined amount.

4. A method of making a mask according to claim 3, wherein the step of identifying the eyes includes identifying the eyebrows, and wherein the step of enlarging the eyes includes enlarging the eyebrows.

5. A method of making a mask according to claim 1 comprising:
identifying the eyes using at least some of the identified preselected facial landmarks; and
whitening the edge margins of the eyes;

6. The method of making a mask according to claim 1 further comprising identifying the center of the eyes using at least some of the identified preselected facial landmarks and coloring a ring around the center of the eyes.

7. The method of making a mask according to claim 6 wherein the step of coloring a ring around the center of each eye comprises coloring a ring with a color based upon an the existing color at a location in the image being colored.

8. The method of making a mask according to claim 6 wherein the step of coloring a ring around the center of each eye comprises selecting one of a number of predetermined colors.

9. The method of making a mask according to claim 6 wherein the step of coloring a ring around the center of each eye comprises coloring the ring with a color selected by a user.

10. The method of making a mask according to claim 1 further comprising identifying the teeth using at least some of the identified preselected facial landmarks and recoloring the teeth that are identified.

11. The method according to claim 10 wherein the teeth are recolored based in part upon a color existing in the image at the location being colored;

12. The method according to claim 10 wherein the teeth are recolored with a predetermined color.

13. The method of making a mask according to claim 10 wherein the teeth are recolored with a color selected by a user.

14. The method according to claim 1 comprising applying one of a plurality of predetermined make up patterns to the image represented by the 3D data based at least in part upon processing the 3D image data.

15. The method according to claim 1 comprising applying one of a plurality of predetermined make up patterns to the image represented by the 3D data based at least in part upon data about the subject.

16. The method according to claim 1 comprising applying one of a plurality of predetermined make up patterns to the image represented by the 3D data based at least in part upon user selection.

17. The method according to claim 1 wherein the step of mating the image represented by the 3D image data to a mask model perform comprises selecting one of a plurality of mask models preforms based upon the distance and or angles between at least two of the preselected facial landmarks.

18. The method according to claim 1 wherein the step of selecting one of a plurality of mask model preforms comprises selecting a preform based at least in part on the distances and or angles between at least two pairs of landmarks.

19. The method according to claim 1 wherein at least two of the distances are substantially perpendicular to each other.

20. The method according to claim 1 wherein the distances are scaled according to the mask model preform selected.

21. The method according to claim 19 wherein the distances are scaled differently in two perpendicular directions.
